(19) United States
(12) Patent Application Publication
(10) Pub. No.: US 2008/0160980 A1
(43) Pub. Date: Jul. 3, 2008

(54) METHOD AND APPARATUS FOR DETERMINING A GROUP CALL WAIT TIME

(75) Inventors: John M. Harris, Chicago, IL (US); Sean S. Kelley, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/676,325

(22) Filed: Feb. 19, 2007

Related U.S. Application Data
(60) Provisional application No. 60/882,263, filed on Dec. 28, 2006.

(51) Int. Cl. H04M 3/00

(52) U.S. Cl. 455/418

(57) ABSTRACT

A user initiates a group call from an initiating communication device to a plurality of group call recipients' communication devices. Then, a processor circuit determines a wait time for commencing communication of the group call according to a predetermined function. The predetermined function is based least in part on status information for at least a portion of the group call recipients wherein the status information includes a likelihood of participation in the group call. The status information used as part of the predetermined function may include various factors relevant to the likelihood of or expecting timing of a group call recipient's joining the call. Perceived delays can be further reduced by storing group call media prior to sending the media to or playing the media at a particular group call recipients' communication devices.

### CROSS-REFERENCE TO RELATED APPLICATION

This application claims priority from provisional application serial no. 60/882,263, entitled “METHOD AND APPARATUS FOR DETERMINING A GROUP CALL WAIT TIME,” filed Dec. 28, 2006, which is commonly owned and incorporated herein by reference in its entirety.

### TECHNICAL FIELD

This invention relates generally to communication devices and systems configured to initiate and participate in group calls and more specifically to managing the start of and participation in such calls.

### BACKGROUND

Various systems provide the ability to organize and execute group calls. Group calls are generally those that are initiated by a first caller and directed at a plurality of call recipients or targets. The initiator selects which recipients to target with the group call. Then, generally, an alert will sound at the initiator's communication device to indicate to the initiator to begin the call. The alert, in prior approaches to group call systems, may be provided according to various protocols.

One approach common in prior group call systems includes waiting to start the group call until every intended recipient accepts the call. Accepting the call for a group call recipient usually entails the recipient's answering the call. Under this approach, however, the group call fails when one of the group call recipients fails to answer the call.

Another approach common in prior group call systems includes starting the group call when a single recipient accepts the group call. Other recipients, however, may miss portions of the call should the initiator of the call begin prior to the acceptance of the call by all of the recipients. Moreover, as other recipients join a group call already in progress, the quality of the group call is typically adversely affected. For instance, the addition of new recipients to a group call may cause audio loss, clipping, delay, or other artifacts in the call.

Yet another prior approach to group call technology includes starting the group call after a predetermined wait time. The predetermined wait time, however, may be too short to allow all of the group call recipients to join the call. Similarly, the predetermined wait time fails to provide flexibility with respect to the likely response time for various collections of group call recipients. For instance, if the group call is directed at a relatively small number of recipients who all quickly answer the call, the predetermined wait time may inject an unnecessary delay in initiating the group call.

### BRIEF DESCRIPTION OF THE DRAWINGS

The above approaches are at least partially improved upon through provision of the method and apparatus for determining a group call wait time described in the following detailed description, particularly when studied in conjunction with the drawings, wherein:

FIG. 1 comprises a block diagram of a system configurable for setting up a group call as configured in accordance with various embodiments of the invention;

FIG. 2 comprises a flow diagram of various methods of handling a group call as configured in accordance with various embodiments of the invention; and

FIG. 3 comprises a flow diagram of various methods of determining a wait time as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a user initiates a group call from an initiating communication device to a plurality of group call recipients' communication devices. Then, a processor circuit determines a wait time for commencing communication of the group call according to a predetermined function. The predetermined function is based at least in part on status information for at least a portion of the group call recipients wherein the status information includes a likelihood of participation in the group call. The status information used as part of the predetermined function may include a rating of the necessity of a group call recipient's participation, a group call recipient's communication device status, a group call recipient's status, a call history for a group call recipient, or other factors relevant to the likelihood of or expected timing of a group call recipient's joining the call. Perceived delays can be further reduced by storing group call media prior to sending the media to or playing the media at a particular group call recipients' communication devices.

So configured, a wait time for starting a group call can be dynamically adjusted based on a number of factors relevant to the participation in and timing of acceptance by recipients of a group call. The factors considered by the predetermined function for determining the wait time can be tailored for a particular situation. By better matching the wait time to the circumstances of a particular group call, undue delay may be decreased and call quality can be increased.

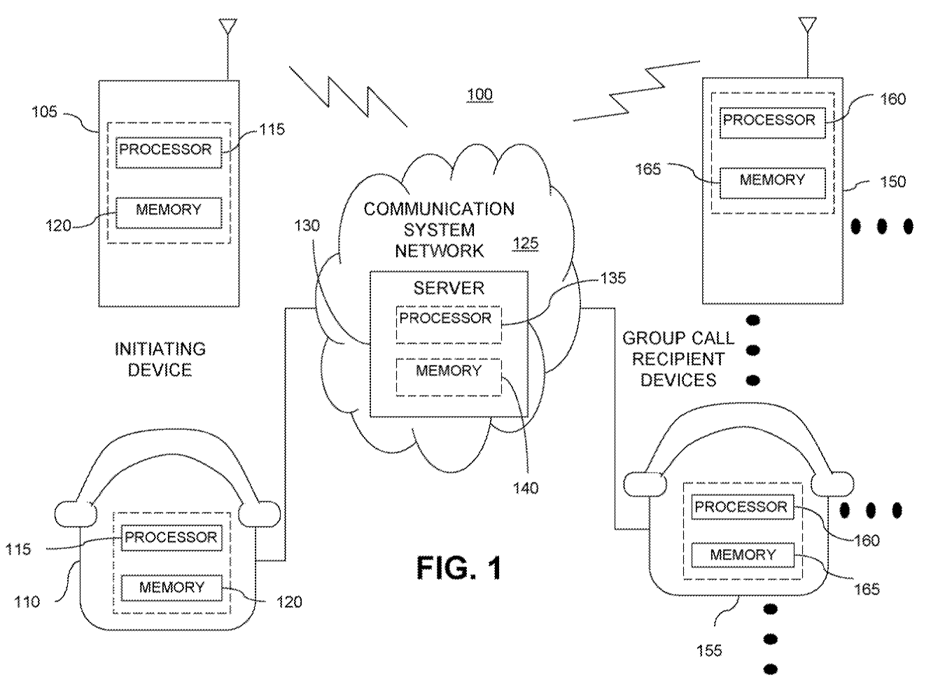

These and other benefits may become clearer upon making a thorough review and study of the following detailed description. Referring now to the drawings, and in particular to FIG. 1, an example communications system 100 for making a group call will be described. The initiating device for a group call may be either a mobile communication device 105 or a wired communication device 110, such as a land-line phone, Internet based phone, or the like. The initiating device 105 or 110 includes a processor 115 and memory 120. When initiating a group call, the initiating device 105 or 110 establishes a connection with a communication system network 125. The communication system network 125 may be configured as a wireless communications system or conventional telephony system as are generally known in the art. As part of the network 125, one or more servers 130 may optionally include a processor 135 or memory 140. Group call recipient devices may also include wireless communication devices 150 or wired communication devices 155. The group call recipient communication devices 150 and/or 155 may include a processor 160 and/or memory 165.

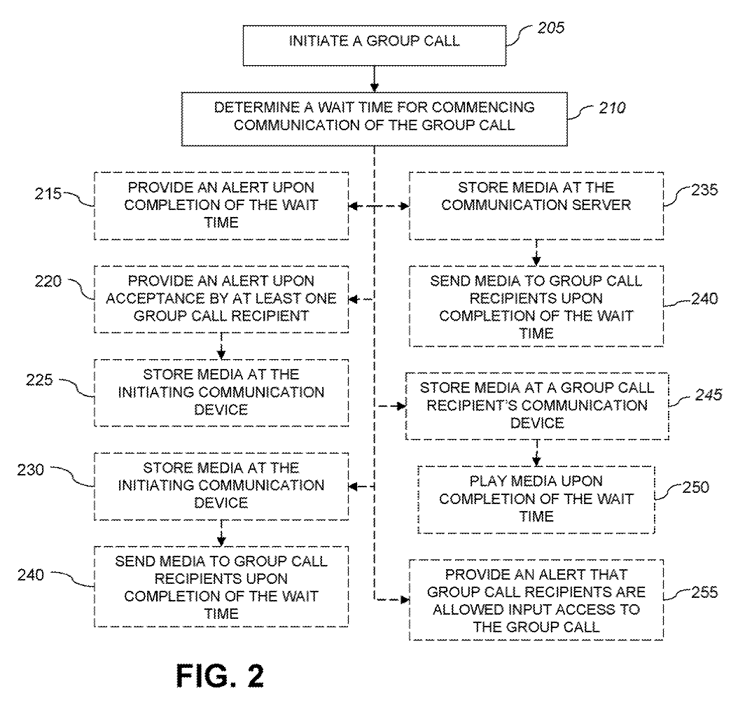

Referring now to FIG. 2, a user initiates 205 a group call from an initiating communication device 105 or 110 to a plurality of group call recipients' communication devices 150 and/or 155. A processor 115, 135, or 160 determines 210 a wait time for commencing communication of the group call according to a predetermined function based at least in part on status information for at least a portion of the group call recipients. The status information typically includes at least in part a likelihood of participation in the group call by one or more group call recipients.

One set of approaches to providing a dynamic wait time centers around the situation where commencing communication of the group call comprises sending media from the initiating communication device 105 or 1 10. These approaches may be generally characterized in that the wait time is in reference to when the media making up the group call is sent from the initiating communication device 105 or 110 to the communications system network 125 for distribution to the group call recipients.

By one approach, an alert is provided 215 at the initiating communication device 105 or 110 in response to an expiration of the wait time. The alert may signal to a user of the initiating communication device 105 or 110 to begin the group call. In this case, the alert, such as an audible beep, a light indicator, vibration of the communication device 105 or 110, or some other indicator to the user cues the user to begin speaking or otherwise start the group call.

By another approach, the alert may be a data packet or signal sent to the initiating communication device 105 or 110 to commence communication of the group call, and/or may include sending the media of the group call from the initiating communication device 105 or 1 10. Typically, the alert will encompass both functions: signaling to the initiating user to begin and beginning the transfer of group call media from the initiating communication device 105 or 110.

By such approaches, the wait time is typically configured as described below to provide enough time for substantially all of the necessary group call recipients to accept the call or most of the group call recipients likely to join the call to accept the call before signaling to the call initiator to begin. By this approach, the group call will typically have improved call quality because of a lessening of the number of recipients joining the call with the call already in progress.

Another approach to configuring the wait time includes providing 220 an alert at the initiating communication device 105 or 110 in response to an acceptance by at least one of the group call recipients, wherein the alert signals to the user of the initiating communication device 105 or 110 to begin the group call. In this case, media for the group call is stored 225 at the initiating communication device 105 or 110 prior to commencing communication of the group call in response to an expiration of the wait time. In this configuration, the delay experienced by the user that initiates the group call is decreased. The benefit in this case is balanced by a delay between the initiation of the group call by the initiating user and the playback of the group call media at the recipients' communication devices 150 and/or 155.

Another set of approaches to providing a dynamic wait time centers around the situation where commencing communication of the group call comprises communicating media to at least one of the group call recipients' communication devices 150 and/or 155 in response to an expiration of the wait time. Such approaches may be generally characterized in that the wait time focuses on the broadcasting of the group call media to the group call recipient communication devices 150 and/or 155 from any of several possible storage or launching locations.

One approach includes storing 230 at least a portion of the media of the group call at the initiating mobile communication device 105 or 110 prior to commencing the communication, wherein commencing the communication occurs in response to an expiration of the wait time. Another approach includes storing 235 at least a portion of the media of the group call at a communication system server 130 memory 140 prior to commencing the communication. Under either example approach, then, the media is sent 240 to the group call recipients after the wait time expires.

This set of approaches minimizes the delay experienced by the initiator of the group call by storing the media of the group call until the calculated wait time expires, whereupon the media is broadcast to the group call recipients. The media may be stored at any appropriate memory 140 location in the communication system 100, such as at a wireless communication base station (not shown) serving a wireless communication device 105 that initiated the group call, a central server 130 for the communication system network 125, or the like. Then, when the wait time expires and in response to an indication that a number of group call recipients have accepted or answered the call, the group call media is sent to the group call recipients' communication devices 150 and/or 155. In this situation, the group call recipients will likely experience a delay after the group call media plays before being able to provide input to the group call. In other words, any delays under such approaches may be split between the initiator and recipients of the group call.

Another approach to providing a dynamic wait time centers around the situation where commencing communication of the group call comprises playing media at one or more of the group call recipients' communication devices 150 and/or 155 in response to an expiration of the wait time. In this approach, at least a portion of the media of the group call is stored 245 at a group call recipient's communication device 150 and/or 155 prior to commencing communication, which in this case includes playing 250 the media in response to an expiration of the wait time. Such approaches may be generally characterized in that the wait time focuses on the playing of the group call media at the group call recipient communication devices 150 and/or 155.

Another approach to providing a dynamic wait time centers around the situation where commencing communication of the group call comprises allowing input access to the group call for at least one of the group call recipients. In certain configurations, group call recipients do not have the ability to contribute to the group call until after the initiator completes at least a portion of the call. In other words, the group call recipients are passive recipients of the group call media until they are allowed access to contribute to the call. In such configurations, an alert is provided 255 to the group call recipients' communications devices 150 and/or 155 in response to an expiration of the wait time, wherein the group call recipients' communication devices 150 and/or 155 are alerted to being allowed input access to the group call. In these cases, the delay for the wait time is experienced after the initial group call media is played at the group call recipients' communication devices 150 and/or 155, and each group call recipient may experience a different individual delay related to when the recipient accepted the call or all the group call recipients may experience a common delay according to the wait time if the group call is played simultaneously for the group call recipients.

As described above, the communications system 100 can be configured to apply the wait time at a variety of places so as to minimize or vary the perceived delay for various participants in group calls. Accordingly, the wait time may be calculated at a variety of places in the communication system 100 and stored or transferred to the appropriate places in the system 100 to apply the wait time. For instance, where the wait time applies to a delay of the alert for the initiating user, the wait time may be calculated at the initiating user's communication device 105 or 110 or in a communication system network server 130 and sent to the initiating user's communication device 105 or 110. Similar configurations are possible for the various approaches and configurations described herein.

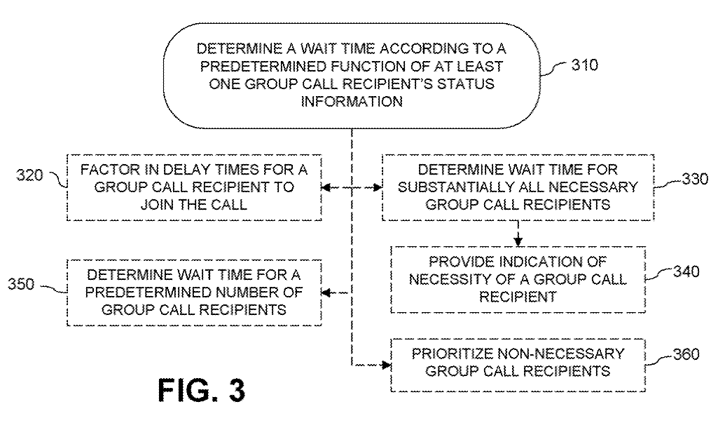

The predetermined function used to determine 310 the wait time will be described further with reference to FIG. 3. The predetermined function is based at least in part on status information that may include any one or more of several variables or factors. For instance, the status information may include a necessity of participation for a group call recipient, a group call recipient's communication device 150 and/or 155 status, a group call recipient's status, a history for the group call recipient, a substantially present availability of a predetermined number of group call recipients, a number of targets, a radio frequency technology of a group call recipient's communication device 150 and/or 155, a paging offset, and/or a communication system 100 status.

In determining the wait time, typically the predetermined function factors 320 in expected response times in joining a call according to status information for at least some of the group call recipients. Accordingly, in certain approaches, the wait time should allow for enough time for a certain number or percentage of group call recipients to accept the call to improve call quality while weighing the inconvenience of extended delays for the group call initiator and/or recipients. Thus, in most examples, the predetermined function calculates the expected response time for the group call recipients based on various factors and information about the recipients, and weighs the expected response times with the necessity of participation and/or resultant delay times in order to determine the wait time. By other approaches, the predetermined function can also weigh the probability that one or more group call targets will ever answer the call given these factors.

For instance, when the status information includes a group call recipient's communication device 150 and/or 155 status, the predetermined function will factor in any one or more various factors that can affect the response time for a recipient. Example factors include whether the device 150 and/or 155 is active with a headset, active within reach of a user, moving among wireless communication device cells, in a stand-by mode, or a land-line device 155. If the device 150 and/or 155 is active with a headset or within reach of a user, for instance, the user can be expected to accept the call in a relatively short period of time. On the other hand, if the device 150 is moving among cells or in a stand-by mode, the user can be expected to accept the call in a relatively longer period of time because the device 150 may experience a delay in receiving notification of the group call when moving among cells or because the device will need to “wake up” from the stand-by mode before alerting a user of the incoming group call. This “wake up” time may be further affected by a paging offset or interval or a next expected “wake up” time for the device 150. If the paging interval or next expected “wake up” time is longer, then the expected response time for a recipient should be accordingly longer. A land-line communication device 155, however, will likely experience less delay than a wireless communication device 150 because it need not handle such variables.

Other factors relating to the group call recipients' communication devices 150 and/or 155 that may bear on the acceptance time include the device's battery life (an indication of losing the target with a low battery life), the device's relative use of radio frequency resources (an indication of likelihood of the call's being dropped or missed), or the like. Similarly, a paging offset between the group call recipients' communication devices 150 and/or 155 and the initiating communication device 105 or 110 or the communication system network 125 can contribute to a delay in acceptance of the call. The communication system 100 status for the group call recipient communication device 150 and/or 155 can also adversely impact the response time if, for example, the communication system 100 is overly loaded. The radio frequency technology of a group call recipient's communication device 150 may also bear on the wait time because certain technologies may have an inherently faster or slower expected time in which a recipient may be notified of the group call.

Similarly, a group call recipient's status can bear on the expected time before the group call recipient accepts a group call. The group call recipient's status may include, for example, a location identifier and/or a personal accessibility identifier. For instance, a group call recipient may set his or her location as “in the office,” “traveling,” “at home,” or the like. These location status identifiers have a corresponding likelihood of the recipient's accepting the group call and the likely time before accepting the call. Similarly, example personal accessibility identifiers may include “in a meeting,” “in a call,” “available,” or the like with a similar bearing on the likelihood and timing of the recipient's accepting the group call.

Where the status information includes a necessity of participation for a group call recipient, the predetermined function includes determining 330 the wait time to provide time for substantially all necessary group call recipients to join the group call. By most approaches, a determination of the necessity of participation for a group call recipient for commencing communication of the group call is provided 340 at the initiating communication device 105 or 110. The user of the initiating communication device 105 or 110 will enter an indication of whether particular targets of the group call are necessary or optional for the call. Based on this information, the predetermined function can adjust the wait time to account for the necessary targets.

The predetermined function may also weigh a recipient's history of accepting group calls. For example, a given group call recipient's average response time to previous group calls may provide an indicator as to the likely response time for the current group call. The recipient's history may also be linked or related to the group call recipient's current status and/or communication device 150 and/or 155 status. In another approach, this history may depend upon the history of that recipient's accepting calls from that particular originator or initiator of the group call or the history of group calls to that particular group. Also, this history may depend upon the history for that particular target recipient in that particular location. In yet another approach, this history may depend upon whether that particular target and initiator had recently been engaged in a call. For example, the historical information can indicate the probability a group call target will answer the call from a particular initiator when the target's status has a particular value and/or the target is in a particular location.

The predetermined function may also weigh information regarding the collection of group call recipients for the group call. For instance, a predetermined number, as set by having a set number or a percentage of the target recipients, of group call recipients may be provided as a target number of participants for a given call. Therefore, the predetermined function may determine 350 the wait time expected for the predetermined number of group call recipients to accept the call. This determination can be made at least in part according to the status information of the targeted recipients. Similarly, this determination can weigh the total number of targeted recipients. For example, the higher the number of targeted recipients, the more quickly a given number is likely to accept. Under different circumstances, the number of targeted recipients can be weighed differently. For instance, if there are a large number of necessary group call recipients or the predetermined number is based on a percentage of a large number of targets, the wait time may be longer to accommodate the large number of necessary group call recipients.

The wait time may also be adjusted according to a prioritization 360 of non-necessary group call recipients. In such an approach, the predetermined function includes prioritizing group call recipients that are determined to not be necessary for commencing communication of the group call according to a predetermined prioritizing function based at least in part on the status information for the non-necessary group call recipients. For instance, an expected response time for a lower priority target may be weighed less in the calculation of the wait time than an expected response time for a higher priority target.

Those skilled in the art will appreciate that the above-described processes are readily enabled using any of a wide variety of available and/or readily configured platforms, including partially or wholly programmable platforms as are known in the art or dedicated purpose platforms as may be desired for some applications. For example, at least a portion of the predetermined function may be executed in at least one of the initiating communication device 105 or 110 processor 115, a communications system server 130 processor 135, and/or a group call recipient's communication device 150 and/or 155 processor 160. Similarly, the status information may be stored one or more of the initiating communication device 105 or 110 memory 120, a communications system server 130 memory 140, and/or a group call recipient's communication device 150 and/or 155 memory 165.

Typically, status information regarding a group call recipient's, group call recipient's communication device's, or communication system's status is stored at the group call recipient's communication device 150 and/or 155 or communication system network server 130. A group call recipient's history may be stored anywhere in the system 100; for example, an initiating user's communication device 105 or 110 may store history information, such as past response times or a history of whether or not there was a response, for each target from past group calls from the initiator. It is contemplated that, depending on the factors weighed by a particular predetermined function, the status information for those factors will be transmitted via the system 100 to the processor 115, 135, or 160 that is calculating the wait time.

For example, an initiating user may initiate a group call through the communication device 150 and/or 155 and through a push-to-talk-over-cellular server (“PoC”) server which may be considered a type of communication system network server 130. The PoC server distributes the group call invitation to each target and meanwhile fetches status information about each target, for example from a Presence Server in the communication system network 125. As the PoC Server receives the status information about each group call recipient or target (possibly from different Presence Servers, if the targets are in different domains), the calculated wait time may change. In this example, the PoC Server calculates the wait time.

As such, a first processor 115 or 135 may be configured and arranged to initiate a group call from an initiating communication device 105 or 110 to a plurality of group call recipients' communication devices 150 and/or 155. A second processor 115, 135, or 160 may then be configured and arranged to determine a wait time for commencing communication of the group call according to a predetermined function based at least in part on status information for at least a portion of the group call recipients. The first processor will typically be the processor 115 associated with the initiating communication device 105 or 110; however, the first processor may be a processor 135 associated with the communications system network 125 that receives information from the initiating communication device 105 or 110 necessary for configuring the call. Similarly, the second processor will typically be located where the wait time will be applied as described above. Thus, the second processor may be located at the initiating communication device 105 or 110, a communications system server 130, and/or a group call recipient's communication device 150 and/or 155. For example, when the wait time is applied to provide an alert to the user of the initiating communication device 105 or 110, the processor 115 may be a processor circuit integral with the initiating communication device 105 or 110 that executes the predetermined function, and the memory 120 may be a memory circuit in operative communication with the processor circuit, wherein the memory circuit stores at least a portion of the status information.

Those skilled in the art will recognize and understand that the processor and memory circuits described herein may be comprised of a plurality of physically distinct elements as is suggested by the illustration shown in FIG. 1. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, those skilled in the art will recognize and appreciate that these teachings offer a flexible and reliable way of tending to improve overall performance of group call handling in a manner that tends to better match many user's expectations by avoiding undue delays or calls that lack an undue number of participants. The balance struck by these teachings are readily scalable and can be leveraged through use with a wide variety of application settings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
initiating a group call from an initiating communication device to a plurality of group call recipients' communication devices;
determining a wait time for commencing communication of the group call according to a predetermined function based at least in part on status information for at least a portion of the group call recipients wherein the status information comprises at least in part a likelihood of participation in the group call.

2. The method of claim 1 wherein commencing communication of the group call comprises sending media from the initiating communication device.

3. The method of claim 2 further comprising providing an alert at the initiating communication device in response to an expiration of the wait time.

4. The method of claim 1 wherein commencing communication of the group call comprises communicating media to at least one of the group call recipients' communication devices in response to an expiration of the wait time.

5. The method of claim 4 further comprising storing at least a portion of the media to one or more of a group comprising:
the initiating mobile communication device prior to commencing the communication, wherein commencing the communication occurs in response to an expiration of the wait time;
a communication system server prior to commencing the communication, wherein commencing the communication occurs in response to an expiration of the wait time.

6. The method of claim 1 wherein commencing communication of the group call comprises playing media at least one of the group call recipients' communication devices in response to an expiration of the wait time and further comprising storing at least a portion of the media at the at least one of the group call recipients' communication devices prior to commencing communication.

7. The method of claim 1 wherein commencing communication of the group call comprises allowing input access to the group call for at least one of the group call recipients.

8. The method of claim 7 further comprising providing an alert to at least one of the group call recipients' communications devices approximately upon completion of the wait time, wherein the at least one of the group call recipients communication devices is alerted to being allowed input access to the group call.

9. The method of claim 1 wherein the predetermined function comprises determining the wait time to factor in expected response times in joining a call according to the status information.

10. The method of claim 1 wherein the status information comprises one or more of a group comprising:
a necessity of participation for a group call recipient;
a group call recipient's communication device status;
a group call recipient status;
a history for the group call recipient;
a substantially present availability of a predetermined number of group call recipients;
a number of targets;
a radio frequency technology of a group call recipient's communication device;
a paging offset;
a communication system status.

11. The method of claim 10 wherein when the status information comprises the necessity of participation for a group call recipient, the predetermined function comprises determining the wait time to provide time for substantially all necessary group call recipients to join the group call.

12. The method of claim 11 wherein a determination of the necessity of participation for a group call recipient for commencing communication of the group call is provided at the initiating communication device.

13. The method of claim 10 wherein the group call recipient's communication device status comprises one or more of a group comprising:
active with a headset;
active within reach of a user;
moving among cells;
in a standby-mode;
a land-line device.

14. The method of claim 10 wherein the group call recipient status comprises one or more of a group comprising:
a location identifier;
a personal accessibility identifier.

15. The method of claim 1 wherein the predetermined function comprises prioritizing group call recipients that are determined to not be necessary for commencing communication of the group call according to a predetermined prioritizing function based at least in part on the status information for the group call recipients that are determined to not be necessary for commencing communication of the group call.

16. The method of claim 1 wherein the predetermined function comprises determining the wait time according to an expected delay before a predetermined number of group call recipients joins the group call.

17. The method of claim 1 further comprising storing the status information in one or more of the group comprising:
the initiating communication device;
a communications system server;
a group call recipient's communication device.

18. The method of claim 1 further comprising executing at least a portion of the predetermined function in one or more of the group comprising:
the initiating communication device;
a communications system server;
a group call recipient's communication device.

19. An apparatus comprising:
a first processor configured and arranged to initiate a group call from an initiating communication device to a plurality of group call recipients;
a second processor configured and arranged to determine a wait time for commencing communication of the group call according to a predetermined function based at least in part on status information for at least a portion of the group call recipients.

20. The apparatus of claim 19 wherein the first processor comprises means for initiating a group call from an initiating communication device to a plurality of group call recipients and the second processor comprises means for determining a wait time for commencing communication of the group call according to a predetermined function based at least in part on status information for at least a portion of the group call recipients.

21. The apparatus of claim 20 wherein the means for determining further comprises:
a processor circuit integral with the initiating communication device, wherein the processor circuit executes the predetermined function; and
a memory circuit in operative communication with the processor circuit, wherein the memory circuit stores at least a portion of the status information.
